(19) United States
(12) Patent Application Publication
(10) Pub. No.: US 2024/0143366 A1
(43) Pub. Date: May 2, 2024

(54) Runtime and Storage Driver Selection for Containers in Distributed Computing Environments

(71) Applicant: RED HAT, INC., Raleigh, NC (US)

(72) Inventors: Alice Frosi, Grasbrunn (DE); Leigh Griffin, Waterford (IE)

(21) Appl. No.: 17/975,337

(22) Filed: Oct. 27, 2022

(51) Int. Cl. G06F 9/455

(52) U.S. Cl. CPC G06F 9/45558; G06F 2009/4557; G06F 2009/45579; G06F 2009/45583

(57) ABSTRACT

A system can be provided that can generate, by a runtime selector of a management node in a distributed computing environment, a mapping that associates each runtime of a set of runtimes to a storage driver of a set of storage drivers. The system can further receive a set of criteria for a software application. The set of criteria can be associated with execution of the software application in the distributed computing environment. Additionally, the system can identify a runtime of the set of runtimes and a storage driver of the set of storage drivers for the software application from the mapping that satisfies the set of criteria for the software application. The system can further generate a container associated with the software application using the runtime and the storage driver.

### TECHNICAL FIELD

The present disclosure relates generally to distributed computing environments and, more particularly (although not necessarily exclusively), to runtime and storage driver selection for containers in distributed computing environments.

### BACKGROUND

Software services such as applications, serverless functions, and microservices can be deployed inside containers within a computing environment. Deploying the software services inside the containers can help isolate the software services from one another, which can improve speed and security and provide other benefits. Containers can be deployed by a container scheduler or orchestration technology from image files using a container engine. An example of an orchestration technology is Kubernetes®.

Image files are often referred to as container images. A container image can be conceptualized as a stacked arrangement of layers in which a base layer is positioned at the bottom and other layers are positioned above the base layer. The base layer may include operating system files for deploying a guest operating system inside the container. The guest operating system may be different from the underlying host operating system of the physical machine on which the container is deployed. Storage drivers can manage contents of the container images. The storage drivers can further enable creation of data in a writable layer of a container (e.g., container layer) and can manage interactions between image layers and the container layer. Additionally, a runtime can be a software component that can create and run containers. In a containerized architecture, the runtime can load the container images from a repository, monitor host operating system resources, and manage container lifecycle.

### BRIEF DESCRIPTION OF THE DRAWINGS

FIG. 1 is a block diagram of an example of a system for implementing runtime and storage driver selection for containers according to one example of the present disclosure.

FIG. 2 is a block diagram of an example of a computing device for implementing runtime and storage driver selection for containers according to one example of the present disclosure.

FIG. 3 is a flowchart of a process for implementing runtime and storage driver selection for containers according to one example of the present disclosure.

### DETAILED DESCRIPTION

Containers can be deployed in isolated computing environments, such as virtual machines. When deployed in the isolated computing environment, the container can inherit a default storage driver that manages where and how the content of image layers of the container is stored. Additionally, by installing or otherwise establishing a runtime, the container can be bound to the default storage driver of the isolated computing environment. But, the default storage driver may not be the most performant option for a workload associated with the container or to a type of runtime used to launch the controller. The workload can be a software application or another suitable software service running in the container. The runtime can launch the container in a more isolated way using virtual machines to protect the underlying computing environment. In an example, the default storage driver can be a file-level storage driver and the workload can be a write-heavy workload. The file-level storage driver can operate at the file level causing the container layer to grow significantly during execution of the write-heavy workload. A block-level storage driver, which operates at the block level to store data without metadata, can offer more efficient storage for virtual or isolated computing environments than file-based storage drivers.

Some examples of the present disclosure can overcome one or more of the abovementioned problems by selecting the runtime and the storage driver for a container based on a set of criteria for a software application. By selecting the runtime and the storage driver, performance metrics, such as speed or security, associated with deploying the software application in a container can be improved. The system can generate a mapping of runtimes to storage drivers based on an availability of runtimes, availability of storage drivers, compatibility of the runtimes and the storage drivers, etc. The mapping can enhance storage, execution, or other suitable aspects of performance for the software application and the container, by ensuring that the storage driver and the runtime associated with the container are compatible or otherwise performant options. The system can also receive the set of criteria for the software application and the set of criteria can be based on client specifications for the software application. For example, the set of criteria can include security preferences, speed preferences, storage preferences, or other suitable criteria. The system can identify, from the mappings, a runtime and a storage driver that can satisfy the set of criteria. The set of criteria can be tailored such that the storage driver and the runtime identified can be based on both performance and for client specifications.

In an example, the system can receive an indication of a set of runtimes from an orchestration platform and an indication of a set of storage drivers from a cloud provider. The system can generate a mapping that associates each runtime of the set of runtimes to at least one storage driver of the set of storage drivers. The system may associate the set of runtimes and the set of storage drivers based on historical data for combinations of runtimes and storage drivers. Additionally, the system can receive a set of criteria for a software application. The set of criteria can include client specifications, application details, or other suitable criteria. The set of criteria may indicate that a secure environment for deploying the software application is a priority for the software application. The system can identify a runtime of the set of runtimes and a storage driver of the set of storage drivers for the software application from the mapping that satisfies the set of criteria for the software application. Thus, the system may identify the runtime and the storage driver that can facilitate the secure environment for the software application. The system may determine that the runtime and the storage driver satisfy the criteria based on historical data associated with performance of the runtime, the storage driver, or a combination thereof. In response to the selection of the runtime and the storage driver, the system can generate a container for deploying the software application using the runtime and the storage driver.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

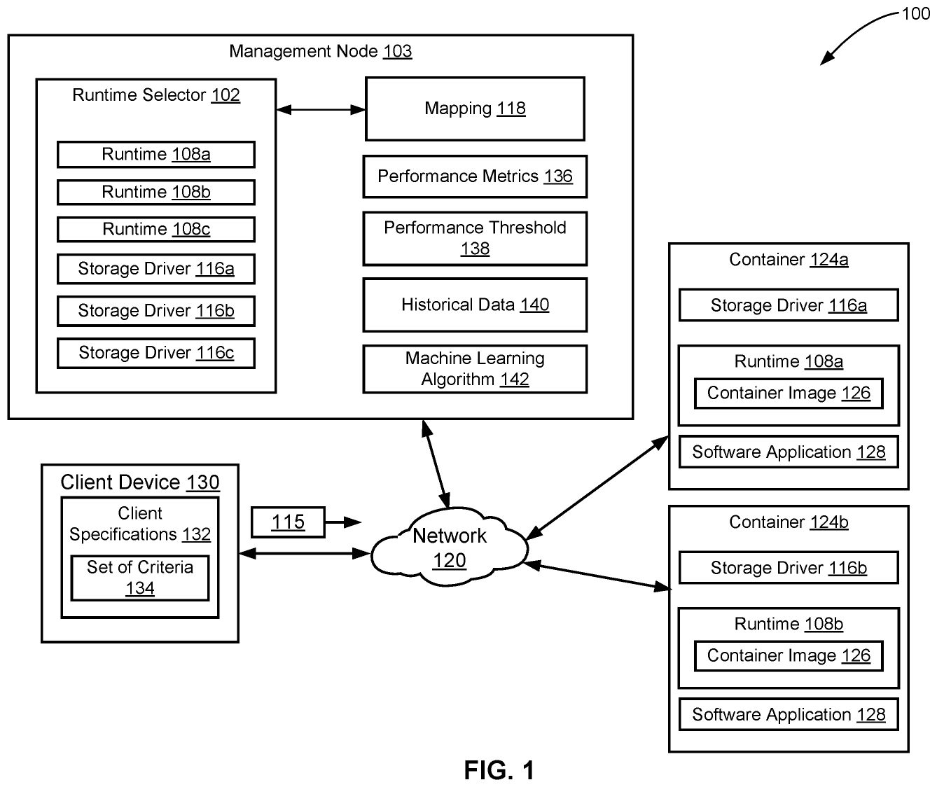

FIG. 1 is a block diagram of an example of a system 100 for implementing runtime and storage driver selection for containers according to one example of the present disclosure. The system 100 can be a distributed computing environment, such as a cloud computing environment, a grid computing environment, a cluster computing environment, etc. The system 100 can include a management node 103 that can include or be communicatively coupled with a client device 130. Additionally, the management node 103 can include a runtime selector 102. In some examples, the management node 103, the client device 130, or other suitable components of the system 100 can communicate via a network 120, such as a local area network (LAN) or the Internet.

In some examples, the runtime selector 102, can generate a mapping 118 that associates each runtime of runtimes 108a-c to each storage driver of storage drivers 116a-c. The runtimes 108a-c can be received by the runtime selector 102 from a container orchestration platform, such as Kubernetes®. The runtimes 108a-c can be software components that can generate and run containers 124a-b on host operating systems. The runtime selector 102 can receive the storage drivers 116a-c from a cloud provider. The storage drivers 116a-c can control how containers 124a-b and container images 126 are stored and managed. Additionally, the storage drivers 116a-c can facilitate storing of data generated or received from a software application 128 in container layers of containers 124a-b.

The runtimes 108a-c and the storage drivers 116a-c received can depend on availability of the runtimes 108a-c, availability of the storage drivers 116a-c, and the compatibility of the runtimes 108a-c and the storage drivers 116a-c. The mapping 118 can be generated based on historical data 140 indicating compatibility of the storage drivers 116a-c and the runtimes 108a-c. The mapping 118 can further be adjusted based on performance metrics 136 of running containers that can be associated with pairs of the storage drivers 116a-c and the runtimes 108a-c. The performance metrics 136 can be execution speed for the software application 128 or other suitable execution metrics, memory usage associated with running the containers, security metrics, etc. In an example, the security metrics can be a security level and the mapping 118 can be generated or adjusted based on the security level. The mapping 118 can be generated or adjusted such that the pairings of the runtimes 108a-c and the storage drivers 116a-c can achieve stronger isolation for the containers and provide appropriate storage for the containers as indicated by the security level.

In some examples, the mapping 118 can be adjusted substantially contemporaneously (e.g., in real time) based on the available runtimes and the available storage drivers. For example, the mapping 118 can include the runtimes 108a-b and the storage drivers 116a-c. The runtime selector 102 can receive a third runtime 108c and, in response, the mapping 118 can be altered to include the third runtime 108c. In an example, the mapping 118 can be altered within a minute of receiving the third runtime 108c. Additionally, the runtime selector 102 can receive updates or other suitable alterations to the runtimes 108a-c or the storage drivers 116a-c, and the runtime selector 102 can adjust the mapping 118 accordingly. For example, the first runtime 108a can be compatible with the first storage driver 116a and an upgrade to the first runtime 108a can enable compatibility with a second storage driver 116b. Thus, the mapping 118 can be adjusted to map the first runtime 108a to the first storage driver 116a and the second storage driver 116b.

Additionally, the runtime selector 102 can receive a set of criteria 134 for the software application 128. The set of criteria 134 can include client specifications 132, application details, or other suitable criteria for generating the containers 124a-b. The client specifications 132 can include execution metrics for the software application, security preferences, storage preferences, or other suitable specifications set by a client or administrator associated with the software application 128. The application details can be characteristics of the software application 128 such as a task performed by the software application 128, an amount of storage associated with running the software application 128, etc. The set of criteria 134 can be sent as a request 115 from a client device 130 and can be adjusted for various software application needs. In an example, the client specifications 132 can include a first requirement for the software application 128 to run in a secure environment and a second requirement for storing a particular amount of data during execution of the software application 128. The set of criteria 134 can reflect the first requirement and the second requirement. Additionally, in some examples, the runtime selector 102 can adjust the mapping 118 based on the set of criteria 134 or the client specifications 132. For example, the runtime selector 102 can update the mapping 118 to exclude storage drivers 116a-c that cannot support efficient creation of an amount of storage space indicated by the set or criteria 134, which can be based on the second requirement.

The runtime selector 102 can further identify that the first runtime 108a and the first storage driver 116a satisfy the set of criteria 134 for the software application 128. In some examples, the mapping 118 may include the runtimes 108a-c and the storage drivers 116a-c that can satisfy the set of criteria 134. Therefore, the runtime selector 102 can identify that the first runtime 108a and the first storage driver 116a can be a most suitable combination for satisfying the set of criteria 134. In additional examples, any number of combinations of the storage drivers 116a-c and the runtimes 108a-c can be in the mapping 118 and the set of criteria 134 can be used to narrow the mapping 118 or identify that the first runtime 108a and the first storage driver 116a can best satisfy the set of criteria 134.

In some examples, the runtime selector 102 may determine a performance threshold 138 based on the set of criteria 134 for the software application 128. The performance threshold 138 can be an execution time, an amount of storage, etc. The runtime selector 102 can identify a combination of a runtime and a storage driver in the mapping 118 that meets or exceeds the performance threshold 138. For example, the runtime selector 102 may identify the first runtime 108a and the first storage driver 116a based on historical data 140, performance metrics 136, or the like indicate that the first runtime 108a and the first storage driver 116a exceed the performance threshold 138.

Additionally, to identify one of the storage drivers 116a-c and one of the runtimes 108a-c, the runtime selector 102 may execute a machine learning algorithm 142. The machine learning algorithm 142 can be a neural network, decision tree, support vector machine, or other suitable machine learning algorithm that can predict which of the storage drivers 116a-c and the runtimes 108a-c satisfy the set of criteria 134. The machine learning algorithm 142 can be trained by inputting previous mappings or combinations of the runtimes 108a-c and the storage drivers 116a-c with lables. The labels can include performance metrics 136, historical data 140, or the like associated with set of criteria 134. After training, the machine learning algorithm 142 can be used by inputting the set of criteria 134 into the machine learning algorithm 142. The runtime selector 102 can receive an output from the machine learning algorithm 142 indicating which of the runtimes 108a-c and the storage drivers 116a-c is predicted to satisfy the set of criteria 134.

The runtime selector 102 can further generate a first container 124a for the software application 128 using the first runtime 108a and the first storage driver 116a. The containers 124a-b can be created and deployed for the software application 128. In some examples, the runtime selector 102 can automatically generate the first container 124a based on the identification of the first runtime 108a and the first storage driver 116a. Additionally or alternatively, the system 100 can display, via the client device 130, a recommendation with the first runtime 108a and the first storage driver 116a to a user. The runtime selector 102 can, in response to the user selecting the recommendation, generate the first container 124a. The system 100 may also provide the mapping 118, additional runtime options, or additional storage driver options to the user via the client device 130. The system 100 may enable the user to select one of the additional runtime options or the additional storage driver options rather than the recommendation. In response, the runtime selector 102 can generate the first container 124a based on the user selection.

In an example, the runtime selector 102 may identify multiple runtime and storage driver combinations that can satisfy the set of criteria 134. For example, the runtime selector 102 may identify that the second runtime 108b and the second storage driver 116b can also satisfy the set of criteria 134 for the software application 128 based on the mapping 118. Therefore, the runtime selector 102 may generate a second container 124b using the second runtime 108b and the second storage driver 116b. The runtime selector 102 may monitor performance metrics 136 associated with the execution of the software application 128 in the first container 124a and performance metrics 136 associated with the execution of the software application 128 in the second container 124b. The runtime selector 102 may adjust a subsequent selection of the first runtime 108a and the first storage driver 116a or the second runtime 108b and the second storage driver 116b based on the performance metrics 136. For example, the performance metrics 136 may indicate that the first runtime 108a and the first storage driver 116a provide more secure data storage for the software application 128, so the subsequent selection may be the first runtime 108a and the first storage driver 116a.

The runtime selector 102 can improve deployment of the software application 128 in containers 124a-b by enabling the selection of the runtime and the storage driver to be optimized for performance and for the client specifications 132. Additionally, the runtime selector 102 can enable customizable and dynamic selection of the runtime and the storage driver. The runtime selector 102 can further facilitate discovery of alternative implementations for runtimes or storage drivers. For example, encrypted data at rest and in transit across a network can be vulnerable to unauthorized access or tampering at runtime. Confidential computing can protect the data while it is being processed via hardware-based Trusted Execution Environments (TEE), which can also increase security for the data at rest and in transit. The TEE can provide a sufficient level of data integrity, data confidentiality, and code integrity. Therefore, the runtime selector 102 may identify storage drivers that can support the TEE or otherwise be used for confidential computing.

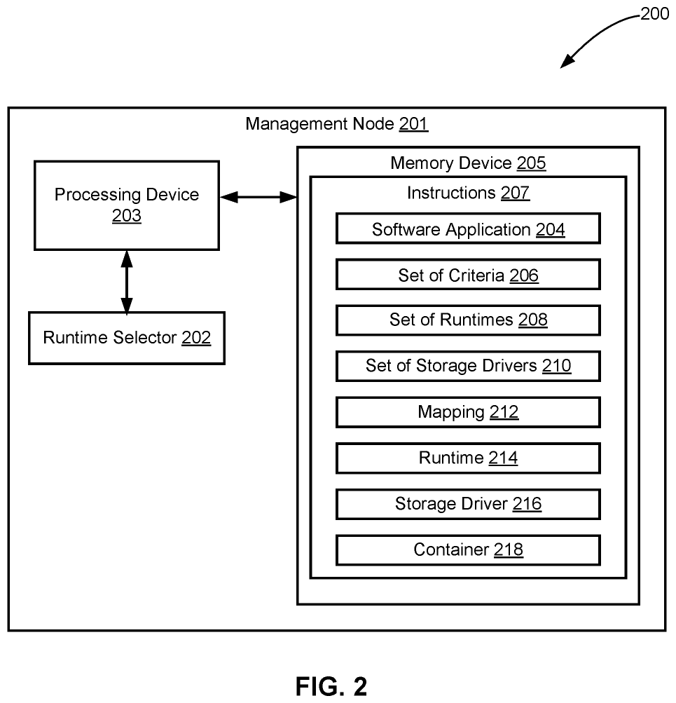

FIG. 2 is a block diagram of an example of a computing device 200 for implementing runtime and storage driver selection for containers according to one example of the present disclosure. The computing device 200 can be part of a distributed computing environment. The computing device 200 includes a processing device 203 that is communicatively coupled to a memory device 205. In some examples, the processing device 203 and the memory device 205 can be part of the same computing device, such as management node 201. In other examples, the processing device 203 and the memory device 205 can be distributed from (e.g., remote to) one another.

The processing device 203 can include one processor or multiple processors. Non-limiting examples of the processing device 203 include a Field-Programmable Gate Array (FPGA), an application-specific integrated circuit (ASIC), or a microprocessor. The processing device 203 can execute instructions 207 stored in the memory device 205 to perform operations. The instructions 207 may include processor-specific instructions generated by a compiler or an interpreter from code written in any suitable computer-programming language, such as C, C++, C #, Java, or Python.

The memory device 205 can include one memory or multiple memories. The memory device 205 can be volatile or non-volatile. Non-volatile memory includes any type of memory that retains stored information when powered off. Examples of the memory device 205 include electrically erasable and programmable read-only memory (EEPROM) or flash memory. At least some of the memory device 205 can include a non-transitory computer-readable medium from which the processing device 203 can read instructions 207. A non-transitory computer-readable medium can include electronic, optical, magnetic, or other storage devices capable of providing the processing device 203 with computer-readable instructions or other program code. Examples of a non-transitory computer-readable medium can include a magnetic disk, a memory chip, ROM, random-access memory (RAM), an ASIC, a configured processor, and optical storage.

The processing device 203 can execute the instructions 207 to perform operations. For example, the processing device 203 can execute instructions 207 to generate, via a runtime selector 202, a mapping 212 that associates each runtime of a set of runtimes 208 to each storage driver of a set of storage drivers 210. The processing device 203 can also receive, via the runtime selector 202, a set of criteria 206 for a software application 204. Additionally, the processing device 203 can identify, by the runtime selector 202, a runtime 214 of the set of runtimes 208 and a storage driver 216 of the set of storage drivers 210 for the software application 204 from the mapping 212 that satisfies the set of criteria 206 for the software application 204. The processing device 203 can further generate, by the runtime selector 202, a container 218 associated with the software application 204 using the runtime 214 and the storage driver 216. The mapping 212 and identification of the runtime 214 and the storage driver 216, by the runtime selector 202, can provide an efficient means to generate the container 218. Additionally, running the software application 204 associated with the container 218 can be improved as the runtime 214 and storage driver 216 identified by the runtime selector 202 can be tailored to satisfy criteria for the software application 204.

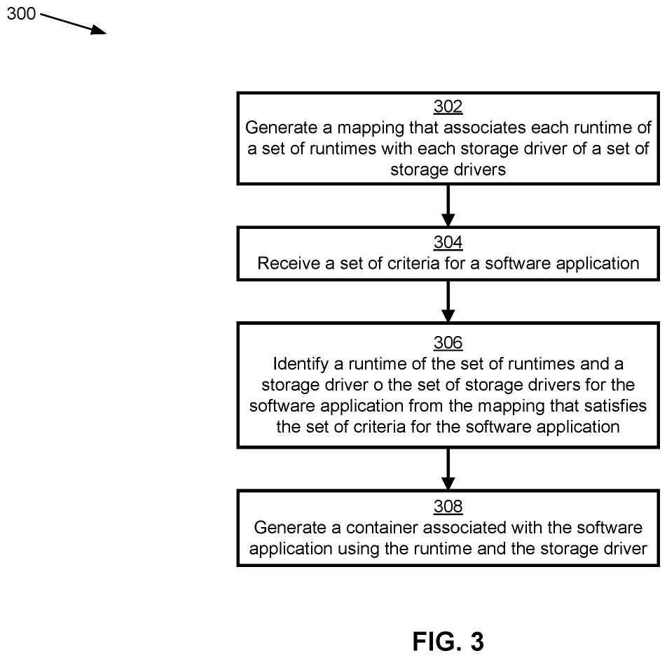

FIG. 3 is a flowchart of a process for implementing runtime and storage driver selection for containers according to one example of the present disclosure. In some examples, the processing device 203 can implement some or all of the steps shown in FIG. 3. Other examples can include more steps, fewer steps, different steps, or a different order of the steps than is shown in FIG. 3. The steps of FIG. 3 are discussed below with reference to the components discussed above in relation to FIG. 1.

At block 302, the runtime selector 102 can generate a mapping 118 that associates each runtime of a set of runtimes to each storage driver of a set of storage drivers. The runtime selector 102 can receive runtimes 108a-c from a container orchestration platform. The runtimes 108a-c can be software components that enable containers 124a-b to run on a host operating system of an isolated environment, such as a virtual machine. The runtime selector 102 can receive storage drivers 116a-c from a cloud provider. The storage drivers 116a-c can control how container images 126 and containers 124a-b are stored, enable modifications to container layers, or provide other suitable storage mechanisms.

In some examples, the runtimes 108a-c and the storage driver 116a-c received and the mapping 118 generated can depend on available runtimes and available storage drivers. For example, a runtime may not be available for a certain workload (e.g., a software application) associated with the runtime or a storage driver may not be available for a certain isolated environment. The runtime selector 102 can further adjust the mapping 118 to map the each of the runtimes 108a-c to each of the storage drivers 116a-c for which the runtimes 108a-c are compatible. For example, a first runtime 108a can be compatible with a first storage driver 116a and the second runtime 108b can be compatible with the storage drivers 116a-c.

At block 304, the runtime selector 102 can receive a set of criteria 134 for a software application 128. The set of criteria 134 can be based on client specifications 132 associated with the software application 128. The set of criteria 134 can include preferences for execution speed, security, accuracy, storage space, etc. In some examples, the mapping 118 can be adjusted based on the set of criteria 134. Additionally, the runtime selector 102 can receive adjustments to the set of criteria 134. In an example, a user may change the client specifications 132 for storage space and the runtime selector 102 can adjust the mapping 118 substantially contemporaneously. For example, in response to the client specifications 132 indicating additional storage space, the mapping 118 can map the first runtime 108a to the first storage driver 116a. The first storage driver 116a can be a block-level storage driver, such as device-mapper, that can pass a container filesystem as a device to improve storage capabilities. In another example, client specifications 132 can indicate high execution speed. Therefore, the mapping 118 may be adjusted to map the first runtime 108a to the second storage driver 116b. The second storage driver 116b may be a file-level storage driver, such as overlay, which can support fast storage when running a container.

At block 306, the runtime selector 102 can identify a runtime of the set of runtimes and a storage driver of the set of storage drivers for the software application 128 from the mapping 118 that satisfies the set of criteria 134 for the software application 128. For example, the runtime selector 102 can identify that the first runtime 108a and the first storage driver 116a satisfy the set of criteria 134. Additionally, in an example, the runtime selector 102 may receive a request 115 from a client device 130. The request 115 can include the set of criteria 134 for the software application 128 and the runtime selector 102 can generate the mapping 118 based on the request 115. The runtime selector 102 can identify the first runtime 108a and the first storage driver 116a from the mapping 118 and provide an indication of the first runtime 108a and the first storage driver 116a to the client device 130 for display to the user.

At block 308, the runtime selector 102 can generate a container associated with the software application 128 using the runtime and the storage driver. For example, a first container 124a can inherit a first storage driver 116a from an isolated environment in which the first container 124a is running. Once the first runtime 108a is installed for first container 124a, the first container 124a can be bound to the first storage driver 116a. Therefore, by identifying the first runtime 108a and the first storage driver 116a as satisfying the set of criteria 134 and mapping the first runtime 108a to the first storage driver 116a to ensure compatibility, the first container 124a can be generated to improve the execution of the software application 128.

In a particular example, the set of criteria 134 can include a security metric and the mapping 118 can be adjusted based on the security metric. Additionally, the runtime selector 102 can identify a second runtime 108b of the set of runtimes and a second storage driver 116b of the set of storage drivers from the mapping 118 that satisfies the security metric. In response, the runtime selector 102 can generate a second container 124b that exhibits stronger isolation than the first container 124a. The stronger isolation can protect data stored in the second container 124b and enable execution of the application 128 in a more secure environment.

Additionally, or alternatively, the process 300 can include identifying, by the runtime selector 102, a second runtime 108b and a second storage driver 116b for the software application 128 from the mapping 118 that can satisfy the set of criteria 134. The runtime selector 102 can generate a first container 124a using the first runtime 108a and the first storage driver 116a and a second container 124b using the second runtime 108b and the second storage driver 116b. The runtime selector 102 may receive performance metrics 136 for execution of the software application 128 in the first container 124a and performance metrics 136 for execution of the software application 128 in the second container 124b. The runtime selector 102 can adjust a subsequent selection of one of the first runtime 108a and the second runtime 108b and one of the first storage driver 116a and the second storage driver 116b based on the performance metrics 136.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device that includes instructions executable by the processing device for causing the processing device to perform operations comprising:
generating, by a runtime selector of a management node in a distributed computing environment, a mapping that associates each runtime of a set of runtimes to each storage driver of a set of storage drivers;
receiving, by the runtime selector, a set of criteria for a software application;
identifying, by the runtime selector, a runtime of the set of runtimes and a storage driver of the set of storage drivers for the software application from the mapping that satisfies the set of criteria for the software application; and
generating, by the runtime selector, a container associated with the software application using the runtime and the storage driver.

2. The system of claim 1, wherein the set of criteria is a first set of criteria, the runtime is a first runtime, the storage driver is a first storage driver, and the container is a first container, and the memory device further includes instructions executable by the processing device to cause the processing device to perform operations comprising:
identifying, by the runtime selector, a second runtime of the set of runtimes and a second storage driver of the set of storage drivers for the software application from the mapping that satisfies the first set of criteria for the software application;
generating, by the runtime selector, a second container associated with the software application using the second runtime and the second storage driver;
receiving, by the runtime selector, first performance metrics for execution of the software application in the first container and second performance metrics for execution of the software application in the second container; and
adjusting a subsequent selection of one of the first runtime and the second runtime and one of the first storage driver and the second storage driver based on the first performance metrics and the second performance metrics.

3. The system of claim 1, wherein the memory device further includes instructions executable by the processing device to cause the processing device to identify the runtime of the set of runtimes and the storage driver of the set of storage drivers for the software application from the mapping that satisfies the set of criteria for the software application by:
determining a performance threshold based on the set of criteria for the software application; and
identifying the runtime and the storage driver based on historical data of the runtime and the storage driver exceeding the performance threshold.

4. The system of claim 1, wherein the memory device further includes instructions executable by the processing device to cause the processing device to perform operations comprising:
receiving, by the runtime selector, an adjustment to the set of criteria; and
adjusting, by the runtime selector, the mapping substantially contemporaneously based on the adjustment to the set of criteria.

5. The system of claim 1, wherein the memory device includes instructions executable by the processing device to cause the processing device to generate the mapping by:
adjusting, by the runtime selector, the mapping substantially contemporaneously based on availability of each runtime of the set of runtimes, compatibility of each storage driver of the set of storage drivers and each runtime of the set of runtimes, and the set of criteria for the software application.

6. The system of claim 1, wherein the set of criteria includes a security metric, the runtime is a first runtime, the storage driver is a first storage driver, and the container is a first container and wherein the memory device includes instructions executable by the processing device to cause the processing device to:
adjust, by the runtime selector, the mapping based on the security metric;
identify, by the runtime selector, a second runtime of the set of runtimes and a second storage driver of the set of storage drivers from the mapping that satisfies the security metric; and
generate, by the runtime selector, a second container that exhibits stronger isolation than the first container using the second runtime and the second storage driver.

7. The system of claim 1, wherein the memory device further includes instructions executable by the processing device to cause the processing device to perform operations comprising:
receiving, by the runtime selector, a request from a client device, the request including the set of criteria for the software application;
generating, by the runtime selector, the mapping based on the request; and
providing, by the runtime selector, the runtime and the storage driver to the client device based on mapping.

8. The system of claim 1, wherein the memory device further includes instructions executable by the processing device to cause the processing device to perform operations comprising:
inputting the set of criteria into a machine learning algorithm; and
receiving an output of the machine learning algorithm indicating the runtime and the storage driver.

9. A method comprising:
generating, by a runtime selector of a management node in a distributed computing environment, a mapping that associates each runtime of a set of runtimes to each storage driver of a set of storage drivers;
receiving, by the runtime selector, a set of criteria for a software application;
identifying, by the runtime selector, a runtime of the set of runtimes and a storage driver of the set of storage drivers for the software application from the mapping that satisfies the set of criteria for the software application; and
generating, by the runtime selector, a container associated with the software application using the runtime and the storage driver.

10. The method of claim 9, wherein the set of criteria is a first set of criteria, the runtime is a first runtime, the storage driver is a first storage driver, and the container is a first container and further comprising:
identifying, by the runtime selector, a second runtime of the set of runtimes and a second storage driver of the set of storage drivers for the software application from the mapping that satisfies the first set of criteria for the software application;
generating, by the runtime selector, a second container associated with the software application using the second runtime and the second storage driver;
receiving, by the runtime selector, first performance metrics for execution of the software application in the first container and second performance metrics for execution of the software application in the second container; and
adjusting a subsequent selection of one of the first runtime and the second runtime and one of the first storage driver and the second storage driver based on the first performance metrics and the second performance metrics.

11. The method of claim 9, wherein identifying the runtime of the set of runtimes and the storage driver of the set of storage drivers for the software application from the mapping that satisfies the set of criteria for the software application further comprises:
determining a performance threshold based on the set of criteria for the software application; and
identifying the runtime and the storage driver based on historical data of the runtime and the storage driver exceeding the performance threshold.

12. The method of claim 9, further comprising:
receiving, by the runtime selector, an adjustment to the set of criteria; and
adjusting, by the runtime selector, the mapping substantially contemporaneously based on the adjustment to the set of criteria.

13. The method of claim 9, further comprising:
adjusting, by the runtime selector, the mapping substantially contemporaneously based on availability of each runtime of the set of runtimes, compatibility of each storage driver of the set of storage drivers and each runtime of the set of runtimes, and the set of criteria for the software application.

14. The method of claim 9, further comprising:
receiving, by the runtime selector, a request from a client device, the request including the set of criteria for the software application;
generating, by the runtime selector, the mapping based on the request; and
providing, by the runtime selector, the runtime and the storage driver to the client device based on mapping.

15. The method of claim 9, further comprising:
inputting the set of criteria into a machine learning algorithm; and
receiving an output of the machine learning algorithm indicating the runtime and the storage driver.

16. A non-transitory computer-readable medium comprising instructions that are executable by a processing device for causing the processing device to perform operations comprising:
generating, by a runtime selector of a management node in a distributed computing environment, a mapping that associates each runtime of a set of runtimes to each storage driver of a set of storage drivers;
receiving, by the runtime selector, a set of criteria for a software application;
identifying, by the runtime selector, a runtime of the set of runtimes and a storage driver of the set of storage drivers for the software application from the mapping that satisfies the set of criteria for the software application; and
generating, by the runtime selector, a container associated with the software application using the runtime and the storage driver.

17. The non-transitory computer-readable medium of claim 16, wherein the set of criteria is a first set of criteria, the runtime is a first runtime, the storage driver is a first storage driver, and the container is a first container and the operations further comprise:
identifying, by the runtime selector, a second runtime of the set of runtimes and a second storage driver of the set of storage drivers for the software application from the mapping that satisfies the first set of criteria for the software application;
generating, by the runtime selector, a second container associated with the software application using the second runtime and the second storage driver;
receiving, by the runtime selector, first performance metrics for execution of the software application in the first container and second performance metrics for execution of the software application in the second container; and
adjusting a subsequent selection of one of the first runtime and the second runtime and one of the first storage driver and the second storage driver based on the first performance metrics and the second performance metrics.

18. The non-transitory computer-readable medium of claim 16, further comprising instructions executable by the processing device to cause the processing device to identify the runtime of the set of runtimes and the storage driver of the set of storage drivers for the software application from the mapping that satisfies the set of criteria for the software application by:
determining a performance threshold based on the set of criteria for the software application; and
identifying the runtime and the storage driver based on historical data of the runtime and the storage driver exceeding the performance threshold.

19. The non-transitory computer-readable medium of claim 16, further comprising instructions executable by the processing device to cause the processing device to perform operations comprising:
receiving, by the runtime selector, an adjustment to the set of criteria; and
adjusting, by the runtime selector, the mapping substantially contemporaneously based on the adjustment to the set of criteria.

20. The non-transitory computer-readable medium of claim 16, further comprising instructions executable by the processing device to cause the processing device to perform operations comprising:
adjusting, by the runtime selector, the mapping substantially contemporaneously based on availability of each runtime of the set of runtimes, compatibility of each storage driver of the set of storage drivers and each runtime of the set of runtimes, and the set of criteria for the software application.
